(19) United States
(12) Patent Application Publication
(10) Pub. No.: US 2012/0178866 A1
(43) Pub. Date: Jul. 12, 2012

(54) RESIN COMPOSITION

(75) Inventors: Shun Kayama, Tokyo (JP); Minoru Tomita, Tokyo (JP); Yukiko Shimizu, Tokyo (JP); Terumitsu Kotani, Tokyo (JP); Kei Takahashi, Tokyo (JP)

(73) Assignees: SHOWA DENKO K.K., Minato-ku, Tokyo (JP); SONY CORPORATION, Minato-ku, Tokyo (JP)

(21) Appl. No.: 13/130,828

(22) PCT Filed: Mar. 31, 2010
(86) PCT No.: PCT/JP10/55892

§ 371 Date: Jul. 26, 2011

(30) Foreign Application Priority Data
Sep. 30, 2009 (JP) 2009-228099

(51) Int. Cl. C08L 67/02; C08K 7/10; C08K 9/00; C08K 7/06; C08K 3/26; C08K 11/00; C08K 3/34; C08K 7/14

(52) U.S. Cl. 524/425; 524/604; 524/513; 524/449; 524/442

(57) ABSTRACT

The resin composition of the present invention is characterized by comprising (A) biodegradable resin, (B) at least one inorganic filler selected from a fibrous inorganic filler, a plate-like inorganic filler, a rod-like inorganic filler and a granular inorganic filler, or an organic filler having water repellency, and (C) a di- or higher functional compound or resin having an isocyanate group. The resin composition of the present invention comprises a biodegradable resin as a main resin component, but can provide molded articles excellent in hydrolysis resistance, mechanical characteristics, and dimensional stability.

### TECHNICAL FIELD

The present invention relates to a resin composition which can provide molded articles excellent in hydrolysis resistance, mechanical characteristics, and dimensional stability.

### BACKGROUND ART

Petroleum resins are used as resin materials for covers and cases for various purposes, chassis of electrical products, and the like, due to their excellent properties such as mechanical characteristics, dimensional stability, workability, and the like. However, in recent years, due to an increasing recognition of the environmental issue, it has been proposed to use biodegradable resins which can be degraded in the natural environment in place of conventional petroleum resins. However, in general, the mechanical characteristics such as tensile strength, tensile modulus, and the like of biodegradable resins are poor, compared with those of petroleum resins and the strength of biodegradable resins decreases by hydrolytic deterioration. Therefore, the use of a biodegradable resin is extremely limited.

A resin composition prepared by formulating plant fiber comprising cellulose and lignin and an isocyanate resin to a biodegradable resin such as polylactic acid or the like at the predetermined ratio was proposed so as to solve these problems.

(For example, see Patent Literature 1.)

### Patent Literature 1 Japanese Patent Application Laid-Open No. 2008-163284

### SUMMARY OF THE INVENTION

### Technical Problem

However, as the mechanical characteristics of molded articles obtained by using the resin composition described in Patent Literature 1 are relatively excellent, but the dimensional stability thereof is poor, there was a problem that the resin composition cannot be used for precision components whose dimensional precision must be high.

Therefore, the present invention is made to solve the above-mentioned problem, and an object thereof is to provide a resin composition which comprises a biodegradable resin as a main resin component and can provide molded articles excellent in hydrolysis resistance, mechanical characteristics, and dimensional stability.

### Solution to Problem

The inventors of the present invention, after conducting intensive studies for solving the conventional problems described above, have found that a resin composition which comprises a biodegradable resin, an inorganic filler having a specific shape or an organic filler having water repellency, and a di- or higher functional compound or resin having an isocyanate group can solve the problems, to complete the present invention.

Namely, the present invention relates to a resin composition comprising (A) biodegradable resin, (B) at least one inorganic filler selected from a fibrous inorganic filler, a plate-like inorganic filler, a rod-like inorganic filler and a granular inorganic filler, or an organic filler having water repellency, and (C) a di- or higher functional compound or resin having an isocyanate group.

It is preferable that component (B) is at least one material selected from a crushed shell material, mica, basalt fiber, glass fiber, carbon fiber, and calcium carbonate or an organic filler having water repellency. An organic filler having a cuticular layer such as mammal hair, insect exoskeleton, molluskan shells and eggs, chaff, or the like is preferable as the organic filler having water repellency. A crushed chaff material is especially preferable among them, considering the availability thereof.

It is preferable that component (B) is formulated in an amount of 20 to 80 wt % with respect to the total of components (A) and (B) and component (C) is formulated in an amount of 0.1 to 5 wt % with respect to the total of components (A) and (C).

It is preferable that component (A) is at least one material selected from biodegradable aliphatic polyesters, biodegradable aliphatic-aromatic copolymerized polyesters, polylactic acid, and copolymers of β-hydroxybutyric acid and β-hydroxyvaleric acid.

It is preferable that the resin composition of the present invention further comprises at least one material selected from acid-modified polyolefins and ethylene-vinyl acetate copolymers.

The resin composition of the present invention may further comprise at least one thermoplastic resin selected from polypropylenes, polystyrenes, acrylonitrile-butadiene-styrene copolymers, polycarbonates, polyethylenes, and thermoplastic elastomers.

In addition, a resin composition suitable for injection molding can be obtained using a biodegradable resin having an MFR (190° C.) of 5 to 300 g/10 minutes as component (A). A resin composition suitable for extrusion molding or foam molding can be obtained using a biodegradable resin having an MFR (190° C.) of 0.1 to 20 g/10 minutes.

### Advantageous Effects of the Invention

According to the present invention, a resin composition which can provide molded articles excellent in hydrolysis resistance, mechanical characteristics, and dimensional stability can be provided. Molded articles obtained using the resin composition of the present invention can be applied to precision components whose dimensional stability must be high.

### DESCRIPTION OF THE EMBODIMENTS

The details on the resin composition according to the present invention will be explained in detail below.

### (A) Biodegradable Resin

The biodegradable resin used in the present invention includes biodegradable aliphatic polyesters, biodegradable aliphatic-aromatic copolymerized polyesters, polylactic acid, copolymers of β-hydroxybutyric acid and β-hydroxyvaleric acid, and the like. They may be used alone or two or more thereof may be used in combination. More specific examples of the biodegradable resin include polybutylene succinate, polycaprolactone, polylactic acid, polybutylene succinate adipate, polyethylene succinate, copolymers of β-hydroxybutyric acid and β-hydroxyvaleric acid, copolymers of terephthalic acid, butanediol, and adipic acid, polyethylene terephthalate/succinate), polyvinyl alcohol, poly(caprolactone/butylene succinate), and the like. Polybutylene succinate is preferable among these biodegradable resins, considering the physical properties and availability thereof. Branched aliphatic polyesters are preferably used in foam molding. Commercially available aliphatic polyesters may be used as the aliphatic polyesters. For example, Bionolle (registered trademark) series manufactured by SHOWA HIGHPOLYMER CO., LTD. and CBS series manufactured by DAICEL CHEMICAL INDUSTRIES, LTD. are exemplified.

It is preferable that the MFR (measured at 190° C. under a 2.16 kg load) of the biodegradable resin is 5 to 300 g/10 minutes, when the resin composition according to the present invention is subjected to injection molding. It is preferable that the MFR (190° C.) of the biodegradable resin is 0.1 to 20 g/10 minutes in extrusion molding or foam molding.

The melting point and the number average molecular weight of the biodegradable resin are not particularly limited. However, it is preferable that the melting point is 90 to 120° C. and the number average molecular weight is 40,000 to 88,000, considering the molding property thereof.

### (B) Inorganic Filler and Organic Filler

The inorganic filler used in the present invention is at least one material selected from a fibrous inorganic filler, a plate-like inorganic filler, a rod-like inorganic filler, and a granular inorganic filler. The shapes of the fibrous, plate-like and rod-like fillers are clear by observing the shapes thereof in most cases. It can be said that those having an aspect ratio of 3 or higher are fibrous, plate-like and rod-like fillers which can be distinguished from indeterminate forms. More specific examples of the inorganic filler include a crushed shell material, mica, basalt fiber, glass fiber, carbon fiber, granular calcium carbonate, and the like. They may be used alone or two or more thereof may be used in combination. It is preferable that granular calcium carbonate is subjected to a surface treatment with a silane coupling agent, a fatty acid, paraffin wax, or the like so as to increase the adhesion thereof to component (A). Examples of the silane coupling agent include silane coupling agents with, for example, a vinyl group, epoxy group, amino group, methacryl group, mercapto group, or the like. Examples of the fatty acid include stearic acid, oleic acid, linoleic acid, and the like. A crushed shell material is preferable among these inorganic fillers in the point that the balance between the properties of the resin composition such as dimensional stability and the like and the cost-effectiveness is excellent. The crushed shell material can be obtained by pulverizing shells of scallop, oyster, Japanese littleneck, clam, pearl oyster or the like using a hammer mill, roller mill, ball mill, jet mill, or the like. The average particle size thereof is preferably 1 to 100 μm, more preferably 5 to 50 μm, the most preferably 5 to 10 μm.

The organic filler used in the present invention has water repellency. The organic filler having water repellency includes organic fillers having a cuticular layer. Specific examples thereof include those obtained by pulverizing mammal hair, insect exoskeleton, molluskan shells and eggs, chaff, and the like into materials having the predetermined particle size. They may be used alone or two or more thereof may be used in combination. A crushed chaff material is preferable among these organic fillers, considering the availability thereof.

In addition, the above inorganic fillers and organic fillers may be used in combination, if necessary.

In the resin composition of the present invention, component (B) above is preferably formulated in an amount of 20 to 80 wt %, more preferably 30 to 60 wt % with respect to the total of components (A) and (B). If the amount of component (B) falls within the above range, a balance between the rigidity and the workability can be much increased.

(C) Di- or higher functional compound or resin having an isocyanate group

The di- or higher functional compound or resin having an isocyanate group used in the present invention has two or more isocyanate groups in one molecule. Examples thereof include 2,4-tolylene diisocyanate, 2,6-tolylene diisocyanate, 2,4′-diphenylmethane diisocyanate, 4,4′-diphenylmethane diisocyanate, polymethylenepolyphenyldiisocyanate, triazine diisocyanate, 1,4-diisocyanatobutane, hexamethylene diisocyanate, 1,5-diisocyanato-2,2-dimethylpentane, 2,2,4-trimethyl-1,6-dilsocyanatohexane, 2,4,4-trimethyl-1,6-diisocyanatohexane, 1,10-diisocyanatodecane, 1,3-diisocyanatocyclohexane, 1,4-diisocyanatocyclohexane, 1-isocyanato-3,3,5-trimethyl-5-isocyanatomethyl-cyclohexane, 4,4′-diisocyanatodicyclohexylmethane, 2,4-hexahydrotoluene diisocyanate, 2,6-hexahydrotoluene diisocyanate, perhydro-2,4′-diphenylmethane diisocyanate, perhydro-4,4′-diphenylmethane diisocyanate, naphthalene 1,5-diisocyanate, xylylene diisocyanate, 1,3-bis(isocyanatomethyl)cyclohexane, tetramethylxylene diisocyanate, and the like, the reaction products of the above compound with a monovalent or polyvalent nonionic polyalkylene ether alcohol, addition products of 2,4-tolylene diisocyanate or 2,6-tolylene diisocyanate hexamethylene diisocyanate with a polyfunctional alcohol, polyisocyanurates, polyisocyanates, polyurethane resins, and the like. They may be used alone or two or more thereof may be used in combination.

Aquanate (registered trademark) 100, 105, 120, 200, and 210 manufactured by NIPPON POLYURETHANE INDUSTRY CO., LTD., Crelan (registered trademark) VPLS2256 manufactured by Bayer Corporation, and the like are exemplified as the commercially available di- or higher functional compounds and resins having an isocyanate group.

In the resin composition of the present invention, component (C) above is preferably formulated in an amount of 0.1 to 5 wt %, more preferably 0.1 to 2 wt % with respect to the total of components (A) and (C). If the amount of component (C) falls within the above range, the strength and the hydrolysis resistance of the molded articles can be much increased.

In addition, at least one material selected from acid-modified polyolefins and ethylene-vinyl acetate copolymers may be formulated in the resin composition of the present invention so as to further increase the strength of the molded articles. The acid-modified polyolefins include graft polymers of a polyolefin such as polyethylene, polypropylene, or the like with a polymerizable carboxylic acid compound and copolymers of a resin material monomer with the polymerizable carboxylic acid compound. The polymerizable carboxylic acid compound includes maleic anhydride, itaconic anhydride, acrylic acid, methacrylic acid, maleic acid, itaconic acid, and the like. They may be used alone or two or more thereof may be used in combination. In particular, maleic anhydride is preferably used in graft polymerization. Acrylic acid, methacrylic acid, and maleic anhydride are preferable in copolymerization. The graft ratio (or copolymerization degree) of the polymerizable carboxylic acid compound in the acid-modified polyolefin is preferably 1 to 30 wt %. The ethylene-vinyl acetate copolymer is obtained by copolymerizing ethylene with vinyl acetate and preferably has a vinyl acetate content of 65 wt % or more, more preferably 70 wt % or more, the most preferably 80 to 99 wt %. Examples of the ethylene-vinyl acetate copolymer having the above vinyl acetate content include powders obtained by spray-drying an ethylene-vinyl acetate copolymer emulsion comprising polyvinyl alcohol as a protective colloid. Lawnf ix 3000 manufactured by SHOWA HIGHPOLYMER CO., LTD., KBE-68A and KBE-68B manufactured by KURARAY CO., LTD., and the like are exemplified as the commercially available products thereof.

When at least one material selected from the acid-modified polyolefins and the ethylene-vinyl acetate copolymers is formulated in the resin composition of the present invention, the formulated amount thereof is preferably 1 to 20 wt % with respect to the total of the resin composition.

In addition, a surfactant may be formulated in the resin composition of the present invention so as to increase the molding workability and the strength of the obtained molded articles. The surfactant includes nonionic surfactants, anionic surfactants, cationic surfactants, ampholytic surfactants, and the like. A nonionic surfactant which is solid at room temperature is preferable among them.

Polyoxyethylene alkyl ethers, polyoxyethylene sorbitol fatty acid esters, and glycerin fatty acid esters manufactured by Kao Corporation, and the like are exemplified as the commercially available products of the surfactant.

When the surfactant is formulated, the formulated amount thereof is preferably 0.1 to 5 wt % with respect to the total of the resin composition.

A publicly known additive other than the above components may be formulated in the resin composition of the present invention such that the level of the effect of the present invention is not decreased. The additive includes surfactants, antioxidants, damage preventing agents, ultraviolet absorbing agents, antistatic agents, flame retardants, lubricants, colorants (dyes and pigments), foaming agents, fragrance materials, and the like. In addition, a publicly known thermoplastic resin such as a polypropylene (PP), a polystyrene, an acrylonitrile-butadiene-styrene copolymer (ABS), a polycarbonate, a polyethylene, a thermoplastic elastomer, or the like may be formulated in the resin composition of the present invention such that the level of the effect of the present invention is not decreased. Examples of the thermoplastic elastomer include styrene-based thermoplastic elastomers, olefin-based thermoplastic elastomers, polyester-based thermoplastic elastomers, polyamide-based thermoplastic elastomers, urethane-based thermoplastic elastomers, nitrile-based thermoplastic elastomers, fluorine-based thermoplastic elastomers, polybutadiene-based thermoplastic elastomers, and silicone-based thermoplastic elastomers.

The resin composition of the present invention can be obtained by uniformly melt mixing the above components using a mixing device, such as an extruder or the like, publicly known in the technical field of the present invention. The mixing temperature is preferably higher than the melting point of the resin by about 10 to 100° C. The resin composition of the present invention may be formed into molded articles by injection molding, blow molding, stretch blow molding, or the like, may be formed into sheet articles by foam sheet molding, board forming or the like, or may be formed into film articles by water-cooled inflation molding, air-cooled inflation molding, extrusion molding with a T-die, extrusion lamination molding, or the like.

### EXAMPLES

The present invention will be specifically explained below with reference to the Examples and Comparative examples, but is not limited thereto.

### Example 1

Melt-mixing of 50 parts by weight of a polybutylene succinate (Bionolle #1010 manufactured by SHOWA HIGHPOLYMER CO., LTD. having a melting point of 110° C., a number average molecular weight of 68,000, and an MFR of 10 g/10 minutes) as the biodegradable resin, 50 parts by weight of a crushed scallop shell material (sieved through 100 mesh) as the inorganic filler, and 0.5 part by weight of Aquanate 105 (manufactured by NIPPON POLYURETHANE INDUSTRY CO., LTD.) as the di- or higher functional compound having an isocyanate group was carried out to obtain a pellet of a resin composition. The pellet was molded into test samples having a length of 30 mm, a width of 15 mm, and a thickness of 2 mm using an injection molding machine.

### Example 2

Test samples were molded in the same manner as in Example 1 except that a crushed chaff material (sieved through 100 mesh) was used in place of the crushed scallop shell material.

### Example 3

Test samples were molded in the same manner as in Example 1 except that the granular calcium carbonate (which had been subjected to a surface treatment with stearic acid and sieved through 100 mesh) was used in place of the crushed scallop shell material.

### Example 4

Melt-mixing of 70 parts by weight of a polybutylene succinate (Bionolle #1050 manufactured by SHOWA HIGHPOLYMER CO., LTD. having a melting point of 110° C., a number average molecular weight of 50,000, and an MFR of 50 g/10 minutes), 30 parts by weight of the crushed scallop shell material (sieved through 100 mesh), 0.5 part by weight of Crelan VPLS2256 (manufactured by Bayer Corporation), and 1 part by weight of a maleic anhydride-modified polypropylene (Umex (registered trademark) 1010 manufactured by Sanyo Chemical Industries, Ltd.) was carried out to obtain a pellet of a resin composition. The pellet was molded into test samples having a length of 30 mm, a width of 15 mm, and a thickness of 2 mm using an injection molding machine.

### Example 5

Melt-mixing of 50 parts by weight of a polybutylene succinate (Bionolle #1010 manufactured by SHOWA HIGHPOLYMER CO., LTD. having a melting point of 110° C., a number average molecular weight of 68,000, and an MFR of 10 g/10 minutes) as the biodegradable resin, 30 parts by weight of a crushed scallop shell material (sieved through 100 mesh) as the inorganic filler, 0.5 part by weight of Aquanate 105 (manufactured by NIPPON POLYURETHANE INDUSTRY CO., LTD.) as the di- or higher functional compound having an isocyanate group, and 20 parts by weight of an ABS (TOYOLAC (registered trademark) 700 314 B1 manufactured by Toray Industries, Inc.) was carried out to obtain a pellet of a resin composition. The pellet was molded into test samples having a length of 30 mm, a width of 15 mm, and a thickness of 2 mm using an injection molding machine.

### Comparative example 1

Test samples were molded in the same manner as in Example 1 except that corn starch (manufactured by Nihon Corn Starch Corporation) was used in place of the crushed scallop shell material.

### Comparative example 2

Test samples were molded in the same manner as in Example 2 except that bamboo powders were used in place of the crushed shell material.

### Evaluation of Mechanical Characteristics

The test samples were subjected to tensile testing in accordance with JIS K7162 to determine the tensile strength and tensile modulus thereof. The results thereof are shown in Tables 1 and 2.

### Evaluation of Hydrolysis Resistance

The test samples were placed in a constant temperature incubator at 65° C. and 90% RH and were left for 150 hours. After that, the test samples were taken out from the constant temperature incubator and were left at room temperature for 24 hours. The test samples were subjected to tensile testing to obtain retention rates of the tensile strength to the initial physical properties (physical properties of the test samples immediately after the molding step) and they were evaluated, in accordance with the following standard. The results thereof are shown in Tables 1 and 2.

O: The retention rate after 150 hours is 50% or more.

X: The retention rate after 150 hours is less than 50%.

### Evaluation of Dimensional Stability

The test samples on which marks were made at 10 cm intervals were placed in the constant temperature incubator at 65° C. and 90% RH and were left for 150 hours. After that, the test samples were taken out from the constant temperature incubator and were left at room temperature for 24 hours. The length of the interval between the marks on the test sample was measured to determine an elongation. The results thereof are shown in Tables 1 and 2. Please note that the elongation was an average value obtained by calculation using three measured values.

TABLE 1

| | Exam- | Exam- | Exam- | Exam- | Exam- |
|---|---|---|---|---|---|
| | ple 1 | ple 2 | ple 3 | ple 4 | ple 5 |
| Tensile strength (MPa) | 24.2 | 21.2 | 22.3 | 28.4 | 25.1 |
| Tensile modulus (MPa) | 1370 | 1170 | 1250 | 897 | 1190 |
| Hydrolysis resistance | ◯ | ◯ | ◯ | ◯ | ◯ |
| Elongation (%) | 23 | 41 | 37 | 26 | 25 |

TABLE 2

| | Comparative | Comparative |
|---|---|---|
| | example 1 | example 2 |
| Tensile strength (MPa) | 32.5 | 33.8 |
| Tensile modulus (MPa) | 1870 | 1350 |
| Hydrolysis resistance | ◯ | ◯ |
| Elongation (%) | 230 | 98 |

As is clear from the results shown in Tables 1 and 2, Examples 1 to 5 exhibited elongation of 23%, 41%, 37%, 26%, and 25% and were excellent especially in dimensional stability as well as mechanical characteristics and hydrolysis resistance. In contrast, as Comparative examples 1 and 2 (corresponding to the composite materials of Patent Literature 1) exhibited an elongation of more than 50%, they cannot be used for precision components whose dimensional precision must be high.

1. A resin composition comprising (A) biodegradable resin, (B) at least one inorganic filler selected from a fibrous inorganic filler, a plate-like inorganic filler, a rod-like inorganic filler and a granular inorganic filler, or an organic filler having water repellency, and (C) a di- or higher functional compound or resin having an isocyanate group.

2. The resin composition according to claim 1, wherein component (B) is at least one selected from a crushed shell material, mica, basalt fiber, glass fiber, carbon fiber and calcium carbonate.

3. The resin composition according to claim 1, wherein component (B) is an organic filler coated with a cuticular layer.

4. The resin composition according to claim 3, wherein the organic filler coated with a cuticular layer is a crushed chaff material.

5. The resin composition according to claim 1, wherein component (B) is formulated in an amount of 20 to 80 wt % with respect to the total of components (A) and (B) and component (C) is formulated in an amount of 0.1 to 5 wt % with respect to the total of components (A) and (C).

6. The resin composition according to claim 1, wherein component (A) is at least one material selected from biodegradable aliphatic polyesters, biodegradable aliphatic-aromatic copolymerized polyesters, polylactic acid, and copolymers of β-hydroxybutyric acid and β-hydroxyvaleric acid.

7. The resin composition according to claim 1, further comprising at least one selected from acid-modified polyolefins and ethylene-vinyl acetate copolymers.

8. The resin composition according to claim 1, further comprising at least one thermoplastic resin selected from polypropylenes, polystyrenes, acrylonitrile-butadiene-styrene copolymers, polycarbonates, polyethylenes, and thermoplastic elastomers.

9. A resin composition for injection molding, wherein the MFR (190° C.) of component (A) contained in the resin composition according to claim 1 is 5 to 300 g/10 minutes.

10. A resin composition for extrusion molding or foam molding, wherein the MFR (190° C.) of component (A) contained in the resin composition according to claim 1 is 0.1 to 20 g/10 minutes.

11. The resin composition according to claim 2, wherein component (B) is formulated in an amount of 20 to 80 wt % with respect to the total of components (A) and (B) and component (C) is formulated in an amount of 0.1 to 5 wt % with respect to the total of components (A) and (C).

12. The resin composition according to claim 3, wherein component (B) is formulated in an amount of 20 to 80 wt % with respect to the total of components (A) and (B) and component (C) is formulated in an amount of 0.1 to 5 wt % with respect to the total of components (A) and (C).

13. The resin composition according to claim 4, wherein component (B) is formulated in an amount of 20 to 80 wt % with respect to the total of components (A) and (B) and component (C) is formulated in an amount of 0.1 to 5 wt % with respect to the total of components (A) and (C).
